(19) United States
(12) Patent Application Publication
(10) Pub. No.: US 2012/0055865 A1
(43) Pub. Date: Mar. 8, 2012

(54) CLEANING METHOD AND SYSTEM

(75) Inventors: Saeed H. Mohseni, Sylvania, OH (US); Deepak Mahulikar, North Kingstown, RI (US); Elizabeth Gramm, Clayton, MI (US)

(73) Assignee: Fujifilm Planar Solutions, LLC

(21) Appl. No.: 13/159,915

(22) Filed: Jun. 14, 2011

Related U.S. Application Data
(60) Provisional application No. 61/379,577, filed on Sep. 2, 2010.

(51) Int. Cl. B01D 29/00; B08B 3/12; B08B 3/00; C09K 13/00; C11D 17/00; C09K 13/04; C09K 13/02; B08B 7/04; B08B 9/00

(52) U.S. Cl. 210/348; 134/10; 134/1; 134/184; 134/105; 134/109; 134/22.1; 510/435; 510/109; 252/79.2; 252/79.5; 252/79.1

(57) ABSTRACT

A method for removing particles or deposits from a surface having particles or deposits thereon. The method involves contacting a surface with a chemical composition sufficient to selectively dissolve and remove at least a portion of the particles or deposits from the surface. The chemical composition is compatible with the surface. This disclosure also relates to a system of specially designed equipment for removing particles or deposits from a surface having particles or deposits thereon. The disclosure is useful, for example, in cleaning porous surfaces, media for cartridge, pleated and membrane surfaces, and internal walls of tanks or filter housings.

This application claims the benefit of provisional U.S. Application Ser. No. 61/379,577, filed Sep. 2, 2010, the entirety of which is incorporated herein by reference.

### BACKGROUND

1. Field of the Disclosure

This disclosure generally relates to a method for removing particles or deposits from a surface having particles or deposits thereon. Chemical compositions, e.g., chemical solutions and mixtures, are used to partially or completely dissolve the particles or deposits, and are compatible with the surface. This disclosure also relates to a system of specially designed equipment for removing particles or deposits from a surface having particles or deposits thereon. The disclosure is useful, for example, in cleaning porous surfaces, media for cartridge, pleated and membrane surfaces, and internal walls of tanks or filter housings.

2. Discussion of the Background Art

In a number of industrial applications, porous surfaces and media are used where they come in contact with media containing particles. One obvious example is filters used in many applications. Water filters are porous media that trap particles larger than its pore sizes. Chemical filters do the same. There are many applications where the particle loading can be very high. Many colloidal dispersions have significant particle loading. Colloidal silica dispersions, such as made by Nalco or Akzo Noble Corporation have very high particle loading in excess of 20 weight percent. Other dispersions include paints, biocides, pharmaceutical and food dispersions. These dispersions come in contact with many porous surfaces such as reactor and storage tanks, plumbing, pumps, filters, and the like. Generally, these surfaces are polymeric like high density polyethylene. But ceramic, elastomeric and metallic surfaces also have been used.

Constant contact of these colloidal dispersions with the porous media results in contamination of the surface and clogging of the pores. In the classic example of filtration, the filter media is porous and traps particles larger than the pore size. Eventually these particles fill up the pore and clog it, reducing filtration efficiency and increasing the differential pressure needed to force the colloidal dispersions through the media. At certain point, the pressure is too high to continue any filtration and the filters are replaced.

Colloidal dispersions also are made or stored in tanks with porous surfaces. Many reactors or storage tanks will eventually develop particle contaminated porous surfaces which are stubborn films or deposits of solidified particles. To remove these films, very high pressure water wash, or sometimes mechanical grinding off, methods are used. The main function of these methods is to mechanically loosen the particles and then carry them away.

Tanks and filter housings are complicated enclosures and are not easily accessible. Power washing big tanks or housings requires intricate equipment and, many times, hard to reach places or “dead” locations are not properly cleaned. Because of this issue, tanks are not fully cleaned.

Filters are likely the most common products that get clogged with particles. There have been a number of attempts to recover filtration efficiency of filters. These attempts were done with back flushing the media with high pressure water in the opposite direction. These attempts did not result in full recovery. A major reason for this failure is that very small particles that get trapped inside the filter pores form strong mechanical and sometimes chemical bonds with the filter surfaces. This is shown in FIGS. 1 and 2. The polymeric surfaces of these filters are rough and have small crevices inside in which the small particles accumulate. Mechanical removal of the particles from these rough areas can be very difficult.

Several filter cleaning methods have been described in the art. For example, U.S. Pat. No. 5,776,876 describes an aqueous acidic filter cleaning composition for removing organic biguanide deposits, particularly from swimming pool filters. The filter cleaning composition contains 5% to 60% of a strong acid, 1% to 40% of a surfactant, and 0.5% to 20% of a sequesterant/builder. The filter cleaning composition optionally includes 0.5% to 10% of a water soluble organic solvent, and/or 0.5% to 10% of a nonionic surfactant. There is no mention of chemical or mechanical compatibility of the cleaning compositions, particularly those having high concentrations of strong acids, with the filters.

U.S. Pat. No. 6,723,246 describes a method of cleaning filters clogged with flocculated materials. The method involves determining the nature of the flocculated materials clogged on the filter and adding a dispersing agent to break up the flocculated materials to form dispersed precipitates. The dispersed precipitates are then removed from the filter in a regular cleaning such as backflushing. The dispersing agent is a polyacrylic acid or a derivative of polyacrylic acid including acidic types, sodium salts, ammonium salts, and amine salts. The pH of the dispersing agent solution can range from about 2 to about 7.5. There is no mention of chemical or mechanical compatibility of the dispersing agent solutions, particularly those having a high pH, with the filters.

One area of the industry where micro filtration has become very important is the semiconductor industry. One of the important process steps used to fabricate wafers includes polishing with advanced colloidal dispersions called slurries. See, for example, U.S. Pat. No. 6,083,840. These slurries contain abrasive particles and generally aqueous chemistry like oxidizers, corrosion inhibitors, removal rate enhancers, and the like. These slurries are conventional materials known in the art. Many different type of abrasives are used in these CMP (chemical mechanical polishing) slurries. Alumina, ceria and silica are common. The most common abrasive is silica with colloidal silica being the dominant one along with fumed silica. These are nano particles with mean particle sizes ranging from 10 to 200 nm.

Larger particles in these slurries are undesirable since they can create defects on wafer surfaces. See, for example, U.S. Pat. No. 6,749,488. These larger particles are removed either in the slurry manufacturing process using extensive filtration and/or at the point of use at the wafer fabricator with additional micro filtration.

This advanced filtration is an expensive process. These filters, such as made by Entegrus or Pall Corporation, are depth filters using polypropylene media with nano pores carefully controlled. Unfiltered slurry or colloidal dispersions are forced through these pores and stop large particles from passing. Eventually these trapped large particles will plug the pores, reducing the number available for filtration. The pressure needed to drive these colloidal dispersions through the filter rises and reaches a point where the filters must be replaced. Filter replacement can take a long time, thereby increasing the process cycle time. The clogged particles adhere strongly to the pores and filter surfaces and cannot simply be forced loose with high pressure water.

Once these clogged filters are taken out, they are disposed off as a waste product. Since these are polymeric, it creates a “non green” long term, non biodegradable waste.

Therefore, there is a need for developing a method for cleaning particle contaminated surfaces, in particular, a cleaning method that allows reuse of filters to reduce process costs, and that minimizes the environmental impact by reducing the number of filters that are thrown away in landfills. There is a need for a cleaning method that is environmentally friendly and does not cause any chemical and/or mechanical damage to the media being cleaned.

### SUMMARY OF THE DISCLOSURE

This disclosure relates to a cleaning method for a particle contaminated surface, e.g., porous surfaces, media for cartridge, pleated and membrane surfaces, and internal walls of tanks or filter housings. Cleaning compositions, e.g., chemical solutions and mixtures, are used to partially or completely dissolve the particles without causing any damage to the particle contaminated surface. This allows effective cleaning and reuse of the contaminated media, e.g., filters.

The disclosure relates in part to a method for removing particles or deposits from a surface having particles or deposits thereon, the method comprising contacting the surface with a chemical composition sufficient to selectively dissolve and remove at least a portion of the particles or deposits from the surface, wherein the chemical composition is compatible with the surface.

The disclosure also relates in part to a system for removing particles or deposits from a surface having particles or deposits thereon, the system comprising at least one vessel, at least one enclosure containing a surface having particles or deposits thereon, one or more pumps, and one or more valves; the at least one vessel suitable for holding a chemical composition; wherein the at least one vessel is in fluid communication with the at least one enclosure, and the at least one enclosure is in fluid communication with the at least one vessel, to form at least a primary chemical composition circulation loop.

The disclosure further relates in part to a method for removing particles or deposits from a surface having particles or deposits thereon, the method comprising:

(i) providing at least one vessel suitable for holding a chemical composition; at least one enclosure containing a surface having particles or deposits thereon; and one or more pumps and one or more valves suitable for controlling flow of the chemical composition;

(ii) conveying the chemical composition from the at least one vessel to the at least one enclosure containing a surface having particles or deposits thereon;

(iii) contacting the surface with the chemical composition sufficient to selectively dissolve and remove at least a portion of the particles or deposits from the surface, wherein the chemical composition is compatible with the surface; and

(iv) conveying spent chemical composition from the at least one enclosure to the at least one vessel.

The disclosure yet further relates in part to a composition for removing particles or deposits from a surface having particles or deposits thereon, the composition comprising a chemical composition sufficient to selectively dissolve and remove at least a portion of the particles or deposits from the surface, wherein the chemical composition is compatible with the surface.

The disclosure also relates in part to a media treated by a method, the media comprising a surface having particles or deposits thereon, the method comprising removing particles or deposits from the surface by contacting the surface with a chemical composition sufficient to selectively dissolve and remove at least a portion of the particles or deposits from the surface, wherein the chemical composition is compatible with the surface.

The disclosure further relates in part to a method for preconditioning a media, the media comprising a surface having particles or deposits thereon, the method comprising contacting the surface with a chemical composition sufficient to selectively dissolve and remove at least a portion of the particles or deposits from the surface, wherein the chemical composition is compatible with the surface.

Further objects, features and advantages of this disclosure will be understood by reference to the following drawings and detailed description.

### BRIEF DESCRIPTION OF THE DRAWINGS

FIG. 1 depicts a schematic representation of a particle contaminated porous surface in a filter media. It depicts a typical depth filter showing the porous filter media, a cross section of the porous filter media, and clogged pores with particles.

FIG. 2 depicts a schematic representation of a particle contaminated porous surface with surface roughness.

FIG. 3 depicts a process flow diagram of a filtration system. The chemical composition is circulated through a heater, and then comes into contact with the particle contaminated porous surface in a dynamic fashion.

FIG. 4 graphically depicts an increase of differential pressure through a filter with time.

FIG. 5 depicts a process flow diagram of a filtration system that includes specially designed equipment.

FIG. 6 graphically depicts filtered slurry large particle counts for 1000>0.56 μm after a dynamic filter cleaning process in accordance with Example 5.

FIG. 7 graphically depicts the slurry potassium ion content after each cleaning cycle in accordance with Example 5.

FIG. 8 graphically depicts the time in minutes that the slurry was filtered through the same filters with cleaning cycles in accordance with Example 5.

FIG. 9 graphically depicts data for the slurry after cleaning cycles in accordance with Example 5.

FIG. 10 graphically depicts polish rates and defectivity of the slurry after 13 clean cycles using the same filters as compared to plant and pilot plant controls in accordance with Example 5.

FIG. 11 graphically depicts the time in minutes that the slurry was filtered through the same filter with cleaning methods of sonication with RO/DI (reverse osmosis/deionized) water and KOH solutions in accordance with Example 6.

FIG. 12 graphically depicts filtered slurry large particle counts for 100 μL>0.56 μm after each cleaning cycle in accordance with Example 6.

FIG. 13 shows a filter in a filter housing with sonic or ultrasonic equipment surrounding the filter.

FIG. 14 shows electrolyte particles in filter media and encapsulated particles in filter media that aid in removing particles or deposits from the filter media at a higher rate and expedites dissolution thereof.

### DETAILED DESCRIPTION OF THE PREFERRED EMBODIMENT

This disclosure relates to a cleaning method for particle contaminated surfaces, e.g., porous surfaces, media for cartridge, pleated and membrane surfaces, and internal walls of tanks or filter housings, and solves the problems associated with prior cleaning methods. The cleaning method of this disclosure has the benefit of restoring particle contaminated surfaces to their original condition so they can be reused, thus providing a significant environmental benefit. In the filtration area, the method of this disclosure has a further benefit of reducing cycle time.

In particular, this disclosure relates to a method for removing particles or deposits from a surface having particles or deposits thereon. The method comprises contacting the surface with a chemical composition sufficient to selectively dissolve and remove at least a portion of the particles or deposits from the surface. The chemical composition is compatible with the surface. The method optionally involves using a heating source suitable for supplying energy to the chemical composition. Also, the method optionally involves using at least one ion exchange system suitable for regenerating the chemical composition.

The particles and deposits on the surfaces can include, for example, organic and inorganic particles and deposits that are often produced in semiconductor wastewaters. The method of this disclosure can remove organic materials such as surfactants, polymers, biological compounds, photoresist processing residues, paint solids, plastics residues, dyes, laundry solids, and textile residues. The method of this disclosure can also remove inorganic materials such as ferric or iron oxides and hydroxides, aluminum and its oxides and hydroxides, calcium salts, silica and silicon, backgrind residues, metal particles, metal salts, phosphorus compounds, mining solids, CMP solids from semiconductor fabrication, glass processing solids, and the like.

Semiconductor fabs are large users of CMP solutions. Other users include the glass industry, metals polishing industries, and the like. The CMP solutions are often colloidal or very small particle size suspensions of silica or alumina or cerium oxide or other abrasives. The CMP solutions may also contain oxidizers such as ferric nitrate or potassium iodate or hydrogen peroxide. The CMP solutions may further contain pH adjusting agents such as ammonium hydroxide, sodium hydroxide, potassium hydroxide, organic acids, and the like. They may also contain anti-tarnish agents such as carboxybenzotriazxole; pad residues; silicon particles; metal particles such as tungsten, tantalum, copper, aluminum, arsenic and gallium arsenide; photoresist residues; organic and inorganic low-k layer residues; and the like.

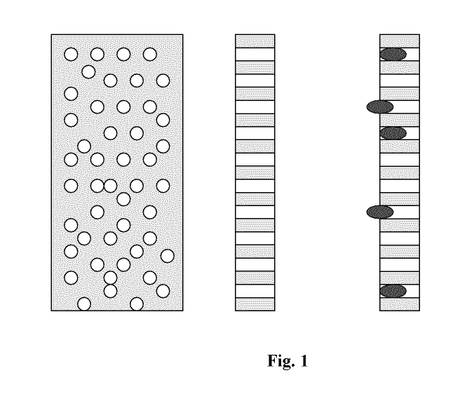

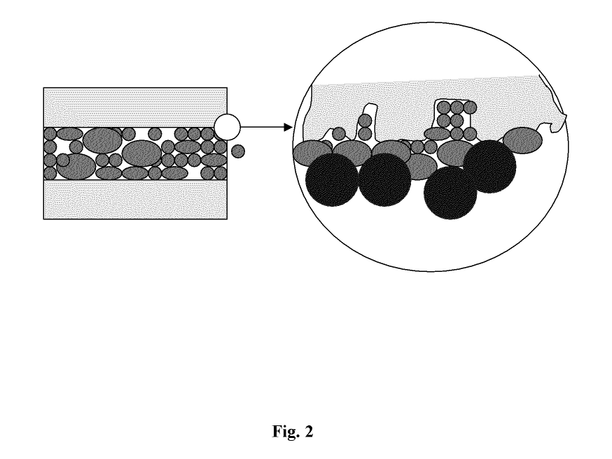

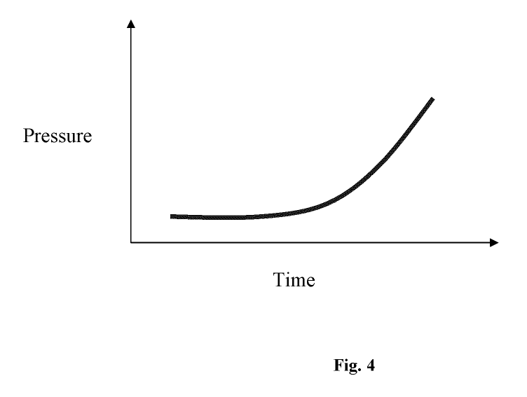

This disclosure relates to a cleaning method for particle contaminated surfaces, e.g., porous surfaces, media for cartridge, pleated and membrane surfaces, and internal walls of tanks or filter housings. Filter media are an example of such a surface. Filters are commonly used in many industrial applications. A typical depth filter is shown in FIG. 1. It is made of a polymeric material and has millions of micro pores in it. Colloidal dispersions pass through this media and particles larger than pore sizes get trapped in the pores. Thus, if one uses a 1 μm absolute filter, then a majority of particles greater than about 1 um size will be caught in the pores. Filtration efficiency is defined by the amount of particles caught versus ones that escape. Good filters are over 95 percent efficient. As more and more of these pores get plugged with particles, a less number of pores is available to filter the colloidal dispersions. Thus, pressure to force these colloidal dispersions through the filters goes up. This is shown in FIG. 4. Once this differential pressure reaches an upper limit, then the filtration process is stopped and the filters are changed. The clogged filters are then disposed off as waste.

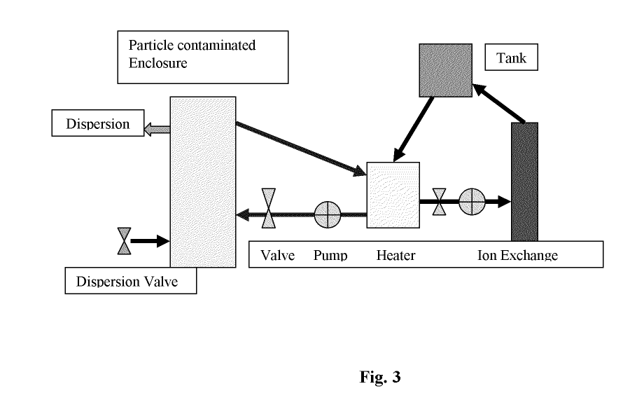

This disclosure provides a solution to this problem. Once the limit pressure is reached, the colloidal dispersions flow is diverted away from the filtration housings. Another chemical distribution loop is activated (see FIG. 3). A heated chemical composition is then sent to the housing and circulated through it. This chemical composition is formulated to partially or completely dissolve these particles without damaging the filter media. Once the dissolution process starts, the particles are dislodged from the pores and carried away. Circulation of the chemical composition assures complete cleaning of the pores. Once the pores are clean, filtration efficiency is restored.

This disclosure relates to compositions for removing particles or deposits from a surface having particles or deposits thereon. The compositions comprise a chemical composition sufficient to selectively dissolve and remove at least a portion of the particles or deposits from the surface. The chemical compositions are compatible with the surface. The chemical compositions for use in the method of this disclosure are selected based on the nature of the particles or deposits on the surface, and also their compatibility with the surface.

After the cleaning or removal of particles or deposits from a media is complete, the original function of the media should be at least partially or fully restored. For example, if a filter media was specified at 95% filtration efficiency prior to cleaning, then the treated media would preferably recover about the same efficiency. Although it is desirable to recover the filtration efficiency to its original level, partial recovery can also be beneficial and is within the scope of this disclosure.

In particular, the chemical compositions useful in this disclosure can include solvents or etchants that are compatible with the surfaces having the particles or deposits thereof. The solvents or etchants can include, for example, organic acids, inorganic acids, alkalis, inorganic salts, organic salts, surface active agents, and mixtures thereof. The chemical compositions can also include, for example, inorganic bases, organic bases, and mixtures thereof.

The chemical composition used in this disclosure should be suited for the type of particles in the pores. For contamination resulting from silica particles, alkalis and their compounds or HF or fluoride compounds are suitable. Suitable compounds include, but not limited to NaOH, KOH, NH₄OH, or their compounds, or mixtures thereof. Other suitable materials include HF, fluoride solutions, and the like. Etchants, which are mixtures of chemicals that can partially dissolve the particles, can also be used. For metallic particles, acids, acidic compounds or etchants as described in Metals Handbook by ASM can be used. It is important to select the chemical composition so that it does not affect the filter media. KOH used in Example 2 satisfies both these needs.

Illustrative chemical compositions, e.g., liquids, gases or vapors, and the particles or deposits on surfaces for which they are suitable include the following:

| Particles | Chemical Compositions |
|---|---|
| Silica | Alkalis and their compounds and HF, |
| | ammonia gas |
| Alumina | Inorganic acids, strong alkalis |
| Ceria | Inorganic acids |
| Metals | Inorganic acids, organic acids, etchants |

This disclosure uses a chemical composition that only reacts with the particles or deposits and not the surfaces to which these particles or deposits are attached. The chemical compositions are compatible with the surfaces. If the surface is polymeric, then many organic solvents can attack the polymer. This is not desirable. Therefore the chemical composition must be chosen such that it only dissolves the particles or deposits without any effect on the substrate. An example in filtration of silica dispersions would be NaOH or KOH solutions that dissolve silica, but have no effect on the filter media (polypropylene).

The pH of the chemical composition solutions should be sufficient so that the chemical composition solution only dissolves the particles or deposits without any adverse effect on the media surface. The pH of the chemical composition solution is preferably from about 1 to about 6, and from about 8 to about 14 for all particles and deposits.

The chemical compositions of this disclosure can be liquid, vapor or gas. Illustrative liquid chemical compositions are described herein. Vapors and gases can be used to selectively dissolve at least a portion of the particles or deposits on the surface. Suitable vapors and gases are compatible with the surface. Illustrative vapors and gases include ammonia gas, HCl, SO₂, and the like. As with liquid chemical compositions, the vapors and gases should be chosen such that they only dissolve the particles or deposits without any adverse effect on the substrate.

The surface having particles or deposits thereon is contacted with the chemical composition sufficient to selectively dissolve and remove at least a portion of said particles or deposits from said surface. As used herein, “dissolve” and “dissolution” means to separate into component parts or to cause to pass into solution and includes “solubilize” and “solubilization”.

The chemical composition is compatible with the surface having particles or deposits thereon. As used herein, “compatible” means that the chemical composition is essentially unreactive with the surface itself, i.e., there is essentially no chemical or mechanical alteration of the surface.

Illustrative surfaces having particles or deposits thereon include, for example, porous surfaces such as filters, media for cartridge, pleated and membrane surfaces, and internal walls of tanks or filter housings. The method of this disclosure can be used to clean most any surface that has been clogged with particles or deposits that have accumulated thereon. Liquid filtration systems that filter solutions such as CMP solutions, glass manufacturing solutions, metal polishing solutions, and the like, can accumulate particles or deposits on the filter surface over time. These particles or deposits can be removed from the filter surface in accordance with the method of this disclosure.

Illustrative filters that may be cleaned in accordance with the method of this disclosure include, for example, hollow fiber membranes, sub-micron level filtering devices, flat sheet membranes or other membrane configurations. The membranes can be formed from PVDF (polyvinylidene fluoride) polymer, polysulfone, polyethylene, polypropylene, polyacrylonitrile (PAN), fluorinated membranes, cellulose acetate membranes, and mixtures of the above, as well as commonly used membrane polymers. A plurality of membranes may be operated together/in parallel to form one filter bank. Multiple filter banks can also be used.

The method of this disclosure is suitable for cleaning filters used in many industrial applications. Such applications include, for example, colloidal silica CMP filters, filters for ink printers that include colloidal dispersants, and the like.

The surfaces having particles or deposits thereon that can be treated in accordance with this disclosure can vary widely. Essentially any type of surface, e.g., porous surface, having particles or deposits thereon can be treated with one or more of the chemical compositions of this disclosure to dissolve and remove at least a portion of the particles or deposits from the surface. The surfaces can include outer or external surfaces of various media, inner or internal surfaces of various media, and/or mixtures thereof. For example, a solid porous media can include both outer surfaces and inner surfaces. This disclosure is not intended to be limited in any manner by the surfaces that can be treated in accordance therewith.

In an embodiment, this disclosure relates to a media treated by the method of this disclosure. The media comprises a surface having particles or deposits thereon. The method comprises removing particles or deposits from the surface by contacting the surface with a chemical composition sufficient to selectively dissolve and remove at least a portion of the particles or deposits from the surface. The chemical composition is compatible with the surface. The media treated by the method of this disclosure can exhibit increased usage and longevity in comparison with untreated media, e.g., filters.

This disclosure also relates to a method for preconditioning a media. The media comprises a surface having particles or deposits thereon. The method comprises contacting said surface with a chemical composition sufficient to selectively dissolve and remove at least a portion of the particles or deposits from the surface. The chemical composition is compatible with the surface. The preconditioned media of this disclosure can exhibit increased efficiency in comparison with untreated media, e.g., filters.

The cleaning time and the chemical composition temperature is decided by the practical aspects of the process. Too long a time will increase the process cycle time. Increased chemical composition temperature will speed up the dissolution process. The chemical composition is preferably heated to a temperature of greater than about 20° C. The desired range of temperature is room temperature to about 60° C. Increased flow of the chemical composition will also accelerate dissolution of the particles and deposits. The chemical composition typically has a circulation flow rate of greater than about 0.1 gallons per minute. The pH of the chemical composition is preferably from about 1 to about 6 and from about 8 to about 14 for all particles and deposits.

While it is preferable to heat the chemical composition, this disclosure also includes heating at least a part of the media surface having particles or deposits thereon. The temperature can be elevated in any location of the system of this disclosure including a separate heating of the chemical composition, the contaminated media surface, or somewhere else in the system.

Reaction conditions for the reaction of the chemical composition with the particles or deposits, such as temperature, pressure and contact time, may also vary greatly. Any suitable combination of such conditions may be employed herein that are sufficient to remove at least a portion of the particles or deposits from surfaces having particles or deposits thereon, e.g. porous surfaces, media for cartridge, pleated and membrane surfaces, and internal walls of tanks or filter housings. The pressure during the cleaning process can range from about 0.1 to about 10 torr, preferably from about 0.1 to about 1.0 torr. The temperature during the cleaning process can range from about 20° C. to about 100° C., preferably from about 22° C. to about 60° C. The reaction time of the chemical composition with the particles or deposits can range from about 30 seconds to about 45 minutes. The preferred reaction time varies depending on the frequency of cleaning that a user practices. The circulation flow rate of the chemical composition can range from about 0.1 to about 10 gallons per minute, preferably from about 0.1 to about gallons per minute.

Following the reaction of the chemical composition with the particles or deposits and removal of at least a portion of the particles or deposits from the surface, the particles or deposits are removed from the surface by their dissolution in the chemical compositions. The particular surface, e.g., internal walls of tanks or filter housings, can then be evacuated and the cleaning process repeated as many times as needed. The evacuated spent chemical composition can be directed to an ion exchange system for regeneration. Repeating the cleaning process can provide media that exhibit increased efficiencies in comparison with media in which the cleaning process was not repeated.

The particles or deposits can be removed from the surface under static or dynamic conditions. In particular, one mode (e.g., static conditions) of this disclosure is directed to cleaning the particles and deposits after they are formed during a preceding process. In an alternative mode (e.g., dynamic conditions), the chemical composition can be supplied continuously while the main process is in progress, e.g. a chemical mechanical polishing (CMP) slurry manufacturing process that uses filtration.

The removal of particles or deposits from the surface can be assisted with removal enhancement methods such as ultrasonic or sound wave assisted vibration of the surfaces. The sonic or ultrasonic equipment can be placed outside or inside the filter housings. See FIG. 16. The use of sonic or ultrasonic equipment can improve particle and deposit removal efficiency. For example, ultrasonic equipment can be used to shake the filter used in conjunction with KOH. For colloidal silica slurries, the slurry is drained from the filtration compartment, KOH is fed therein, the filtration compartment undergoes shaking with ultrasonic waves to speed up the removal of colloidal particles from the filter's pores together with the dissolving thereof by KOH, the filtration compartment or KOH is optionally heated, the filtration compartment is rinsed with water and then replenished with used colloidal silica slurry.

In another embodiment, charged particles and deposits in media can be removed by electrolytic filtration. See FIG. 17. Electrolytic filtration involves adding electrolyte particles to filter media, for example, by synthesizing electrolyte particles on polypropylene fiber molecules. Particles with opposite charge, e.g., opposite to silica charge, will repel filtering particles such as silica. Repletion creates a highly dynamic environment which aids silica to move out of filter media at a much faster rate, which in turn expedites silica dissolution. The charged particles aid the chemical composition to enhance dissolution.

Fully encapsulated nano metallic particles such as iron within filter media can also be used in this disclosure. Filter cleaning can exponentially be enhanced by exposing the filter to sound such as mega or ultrasound. Sound causes the encapsulated iron particles to vibrate within the filter media creating a highly uniform dynamic movement. The movements lead silica particles out of the filter media at a higher rate which expedites silica dissolution. The encapsulated particles should be built permanently within the media fibers to ensure they will not be released into the chemical composition.

The method of this disclosure includes cleaning the surfaces of media in a static vessel. For example, clogged filters can be removed from the main process, transported to a static vessel containing the chemical composition, and cleaned in the static vessel. In the static cleaning, the media, e.g., filters, can be soaked in the chemical composition at or above 20° C. for a length of time sufficient to dissolve and remove the particles or deposits. The cleaned filters can then be returned to the main process. The cleaning can be conducted on site or off site. As indicated above, the method of this disclosure can be carried out in situ with a main process that utilizes a media, e.g., filter, in which particles or deposits accumulate thereon during the process. In the dynamic condition, the media, e.g., filters, can be cleaned with the flowing chemical composition.

The chemical composition, after it dissolves the particles, can be further regenerated by sending it through an ion exchange process. For example, the KOH used in the examples will dissolve silica to form K-silicate. In a standard ion exchange process, one can recover the K ion and get KOH back and only discard silicic acid gel which is environmentally friendly.

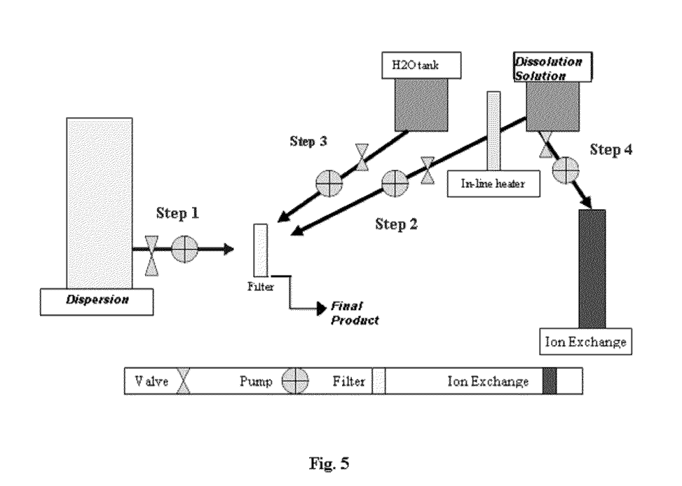

Referring to FIG. 5, this disclosure relates to a method for removing particles or deposits from a surface having particles or deposits thereon. The following equipment is used in this method: at least one vessel, e.g., tank, suitable for holding a chemical composition; optionally at least one heating source, e.g., heater, suitable for supplying energy to the chemical composition or any other part of the loop including, but not limited to, the particle or deposit contaminated porous surface; at least one enclosure containing a surface having particles or deposits thereon, e.g., particle contaminated enclosure; one or more pumps and one or more valves suitable for controlling flow of the chemical composition. The chemical composition is conveyed from the at least one vessel to the at least one heating source, and the chemical composition is heated. The heated chemical composition is then conveyed from the at least one heating source to the at least one enclosure containing a surface having particles or deposits thereon. The surface is contacted with the heated chemical composition sufficient to selectively dissolve and remove at least a portion of the particles or deposits from the surface. The heated chemical composition is compatible with the surface. Spent chemical composition is then conveyed from the at least one enclosure to the at least one heating source.

The method of this disclosure relates to removing particles or deposits from a surface having particles or deposits thereon. The method includes providing at least one vessel suitable for holding a chemical composition; at least one enclosure containing a surface having particles or deposits thereon; and one or more pumps and one or more valves suitable for controlling flow of the chemical composition; conveying the chemical composition from the at least one vessel to the at least one enclosure containing a surface having particles or deposits thereon; contacting the surface with the chemical composition sufficient to selectively dissolve and remove at least a portion of the particles or deposits from the surface, wherein the chemical composition is compatible with the surface; and conveying spent chemical composition from the at least one enclosure to the at least one vessel.

In an embodiment, the method of this disclosure further includes providing at least one heating source suitable for supplying energy to said chemical composition; conveying said chemical composition from said at least one vessel to said at least one heating source; conveying said chemical composition from said at least one heating source to said at least one enclosure containing a surface having particles or deposits thereon; conveying spent chemical composition from said at least one enclosure to said at least one heating source; and conveying said spent chemical composition from said at least one heating source to said at least one vessel.

In another embodiment, the method of this disclosure further includes providing at least one ion exchange system suitable for regenerating said chemical composition; conveying said spent chemical composition from said at least one enclosure to said at least one ion exchange system, and regenerating said spent chemical composition; and conveying regenerated chemical composition from said at least one ion exchange system to said at least one vessel.

In yet another embodiment, the method of this disclosure further includes providing at least one ion exchange system suitable for regenerating said chemical composition; conveying said spent chemical composition from said at least one heating source to said at least one ion exchange system, and regenerating said spent chemical composition; and conveying regenerated chemical composition from said at least one ion exchange system to said at least one vessel.

Referring to FIG. 5, the method optionally involves using at least one ion exchange system suitable for regenerating the chemical composition. Spent chemical composition is conveyed from the at least one heating source to the at least one ion exchange system, where it is regenerated. The regenerated chemical composition is then conveyed from the at least one ion exchange system to the at least one vessel. The regenerated chemical composition is conveyed from the at least one vessel to the at least one heating source.

This disclosure can also be used to clean tank surfaces. For example, colloidal dispersions are stored in high density polyethylene tanks and, over a period of time, a thin coating of silica forms on the surfaces. This is very hard to clean, especially in hard to reach places. The cleaning can be easily accomplished with the heated chemical composition of this disclosure.

This disclosure has a number of benefits including, but not limited to, economic and environmental. Economic benefits are self evident. Reusing the filters reduces process costs. Environmental impact can be more significant. Hundreds and thousands of filters are thrown in the land fill. They are not biodegradable. By reusing the same filters, the savings to the environment are very significant.

This disclosure relates to a system of specially designed equipment for removing particles or deposits from a surface having particles or deposits thereon. An illustrative system having specially designed equipment is shown in FIG. 5.

In particular, this disclosure relates to a system for removing particles or deposits from a surface having particles or deposits thereon. The system comprises at least one vessel, at least one enclosure containing a surface having particles or deposits thereon, one or more pumps, and one or more valves. The at least one vessel is suitable for holding a chemical composition. The at least one vessel is in fluid communication with the at least one enclosure. The at least one enclosure is in fluid communication with the at least one vessel. This arrangement forms at least a primary chemical composition circulation loop. This system including the primary chemical composition circulation loop can be portable or permanent.

This system optionally includes at least one heating source. The at least one heating source is suitable for supplying energy to the chemical composition. The at least one vessel is in fluid communication with the at least one heating source. The at least one heating source is in fluid communication with the at least one enclosure. The at least one enclosure is in fluid communication with the at least one heating source. The at least one heating source is in fluid communication with the at least one vessel. This arrangement forms at least a secondary chemical composition circulation loop. See FIG. 5. This system including the secondary chemical composition circulation loop can also be portable or permanent.

This system optionally includes at least one ion exchange system. The ion exchange system is suitable for regenerating the chemical composition. The at least one vessel is in fluid communication with the at least one enclosure. The at least one enclosure is in fluid communication with the at least one ion exchange system. The at least one ion exchange system is in fluid communication with the at least one vessel. This arrangement forms at least a secondary chemical composition circulation loop. See FIG. 5. This system including the secondary chemical composition circulation loop can also be portable or permanent.

In another embodiment, the system of this disclosure optionally includes both a heating source and an ion exchange system. The at least one ion exchange system is suitable for regenerating the chemical composition. The at least one heating source is suitable for supplying energy to the chemical composition. The at least one vessel is in fluid communication with the at least one heating source. The at least one heating source is in fluid communication with the at least one enclosure. The at least one enclosure is in fluid communication with the at least one heating source. The at least one heating source is in fluid communication with the at least one ion exchange system. The at least one ion exchange system is in fluid communication with the at least one vessel. This arrangement forms at least a tertiary chemical composition circulation loop. See FIG. 5. This system including the tertiary chemical composition circulation loop can also be portable or permanent.

A chemical composition discharge line can extend exteriorly from at least one outlet opening of the at least one vessel to at least one inlet opening of the at least one heating source. The chemical composition discharge line can contain at least one chemical composition flow control valve therein for control of flow of the chemical composition liquid therethrough.

A chemical composition discharge line can extend exteriorly from at least one outlet opening of the at least one heating source to the at least one inlet opening of the at least one enclosure through which the chemical composition can be dispensed to the surface having particles or deposits thereon. The chemical composition discharge line can contain at least one chemical composition flow control valve therein for control of flow of the chemical composition liquid therethrough.

A spent chemical composition discharge line can extend exteriorly from at least one outlet opening of the at least one enclosure to at least one inlet opening of the at least one heating source. The spent chemical composition discharge line can contain at least one spent chemical composition flow control valve therein for control of flow of the spent chemical composition liquid therethrough.

A spent chemical composition discharge line can extend exteriorly from at least one outlet opening of the at least one heating source to at least one inlet opening of the at least one ion exchange system. The spent chemical composition discharge line can contain at least one spent chemical composition flow control valve therein for control of flow of the spent chemical composition liquid therethrough.

A regenerated chemical composition discharge line can extend exteriorly from at least one outlet opening of the at least one ion exchange system to at least one inlet opening of the at least one vessel. The regenerated chemical composition discharge line can contain at least one spent chemical composition flow control valve therein for control of flow of the regenerated chemical composition liquid therethrough.

The particle contaminated enclosure (such as filters, housings or tanks) are designed for two different circulation loops. The standard dispersion loop is where the dispersion is brought in and taken out. If this was filter housing, then the colloidal dispersions will be pushed through a pump and a valve and the filtered dispersion would leave the housing through an outlet.

When the particle contaminated porous surface of the housing needs cleaning, one would simply shut off the valve for the dispersion loop and turn on the valve for the cleaning loop. This loop contains a tank to store the chemical composition, a heating source, e.g., a heater, an ion exchange system, valves and pump. The equipment may also include metrology for in process controls. The chemical composition after circulating through the enclosure can be sent to the ion exchange for regeneration. The ion exchange loop is optional.

The chemical cleaning loop can be portable or permanent. The ion exchange loop can also be portable or permanent.

In another embodiment, referring to FIG. 3, silica is dispersed from a silica dispersion tank through filters and on to a silica packaging station until the filters plug (see steps 1 and 2). Differential pressures of 15 psi can be used as an indicator of filter plug. Once the filters plug, steps 1 and 2 are shut down, and the silica dispersion is pumped out of the filter housings back to the silica dispersion tank. Heated KOH is recirculated through the filters for about 10 minutes or until all of the silica is dissolved (see step 3). KOH is then pumped out of the filters and back to the KOH tank. Step 3 is then shut down and step 4 is used to rinse the filters until the pH is lowered to the desired level. Water is pumped out of the filters and back to the water tank. Steps 1-4 are repeated about 10 times or until the KOH is saturated with about 10 percent silica. All steps are then shut down and the percent total solids in the KOH tank is measured. If the percent total solids in the KOH is higher than about 10 percent, step 5 is used to ion exchange the KOH back to its fresh condition. The entire filtration system is then ready to repeat steps 1-5.

A control system and methodology can optionally be utilized in the operation of a cleaning system which is configured to enable automatic, real-time optimization and/or adjustment of operating parameters to achieve desired or optimal operating conditions. Suitable control means are known in the art and include, for example, a programmable logic controller (PLC) or a microprocessor.

A computer implemented system can optionally be used to control supply rates of the chemical composition, heating of the chemical composition, settings on pressure and relief valves, and the like. The computer control system can have the ability to adjust different parameters in an attempt to optimize the removal of particles and deposits from surfaces having particles or deposits thereon. The system can be implemented to adjust parameters automatically. Control of the cleaning system can be achieved using conventional hardware or software-implemented computer and/or electronic control systems together with a variety of electronic sensors. The control system can be configured to control supply rates of the chemical composition, heating of the chemical composition, settings on pressure and relief valves, and the like.

The cleaning system can further comprise sensors for measuring a number of parameters such as chemical composition supply rates, heating of the chemical composition, pressure and relief valves, and the like. A control unit can be connected to the sensors and at least one of the inlet openings and outlet openings for conveying the chemical composition throughout the system in accordance with the measured parameter values.

The computer implemented system can optionally be part of or coupled with the cleaning system. The system can be configured or programmed to control and adjust operational parameters of the system as well as analyze and calculate values. The computer implemented system can send and receive control signals to set and control operating parameters of the system. The computer implemented system can be remotely located with respect to the cleaning system. It can also be configured to receive data from one or more remote cleaning systems via indirect or direct means, such as through an ethernet connection or wireless connection. The control system can be operated remotely, such as through the Internet.

Part or all of the control of the cleaning system can be accomplished without a computer. Other types of control may be accomplished with physical controls. In an instance, a control system can be a manual system operated by a user. In another example, a user may provide input to a control system as described. A suitable pressure gauge may be used to monitor supply rates (for example, chemical composition delivery rates).

It will be appreciated that conventional equipment can be used to perform the various functions of the cyclic processes, such as monitoring and automatically regulating the flow of gases within the cyclic adsorption system so that it can be fully automated to run continuously in an efficient manner.

Various modifications and variations of this disclosure will be obvious to a worker skilled in the art and it is to be understood that such modifications and variations are to be included within the purview of this application and the spirit and scope of the claims.

### Example 1

A fumed silica dispersion was circulated through three filter housings with filter pores ranging between 0.1-1 microns in size. These tight pores are considered more challenging to be reconditioned in contrast to pores higher than one micron size. Once the filters plugged, pressurized water was circulated through the filters. The fumed silica dispersions were re-filtered. However the differential pressure had not come down, indicating that the pores were still clogged.

### Example 2

Through the same filters described in Example 1, a heated (50° C.) KOH aqueous solution was circulated for 10 minutes. Water rinse followed to rinse off KOH and decrease the pH. Only then, filters were reconditioned and ready for re use. Fumed dispersions were then filtered through the same filters. The LPC (Large Particle Counts), MPS (Mean Particle Size), % TS (Total Solids) data of fumed silica show complete cleaning and recovery of filtration efficiency.

### Example 3

The process in Example 2 was repeated on the same filters for several times. Every time the cleaning resulted in complete recovery of filtration efficiency.

### Example 4

The process in Example 2 was repeated. Surprisingly, for every new flush cycle, gradual improvement of filtration efficiency was noticed. The LPCs were lower for each cycle.

### Example 5

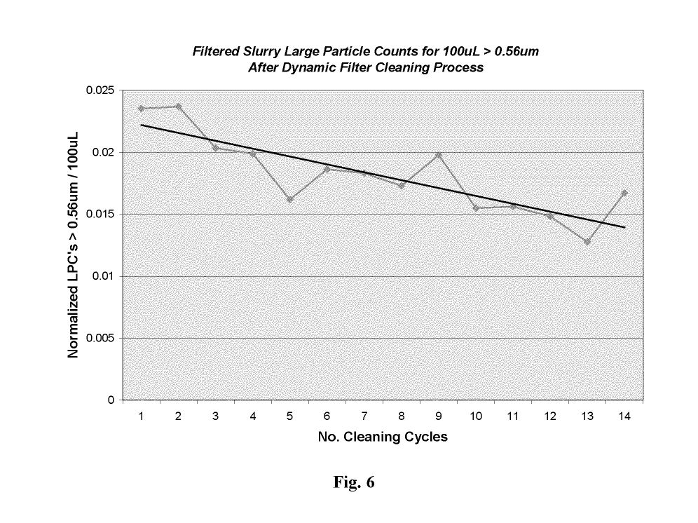

A cartridge filter (Pall 0.5 um A) was installed in a standard 10 inch filter housing for each experiment. A slurry (i.e., fumed silica dispersion) was pumped through the housings at a steady rate of 1.2 liters/minute. The slurry pumping was continued until a differential pressure of 12 psi was achieved on any one filter. A dip tube into unfiltered material was pulled, and the housings were pumped through and drained of residual slurry. A first water rinse was then pushed through. A 22.5% KOH solution at a temperature of 50° C. was recirculated through for 10 minutes then pushed through. A second water rinse was pushed through and the housings were drained of any residual water. Filtration was started again with the slurry, and the above steps were repeated until a desired quantity was filtered (in this case 300 kilograms). Each cut of slurry was put through the filters prior to achieving the differential pressure of 12 psi. The composite filtered slurry was sampled for LPCs (Large Particle Counts). The pH, MPS (Mean Particle Size), LPCs, and potassium ion content were taken for each cut of slurry. For control testing, samples were filtered with same filter set up as above but no rinsing or cleaning of the filters occurred. Once the filter achieved a differential pressure of 12 psi, it was thrown away and replaced. The results are shown in FIGS. 6-10.

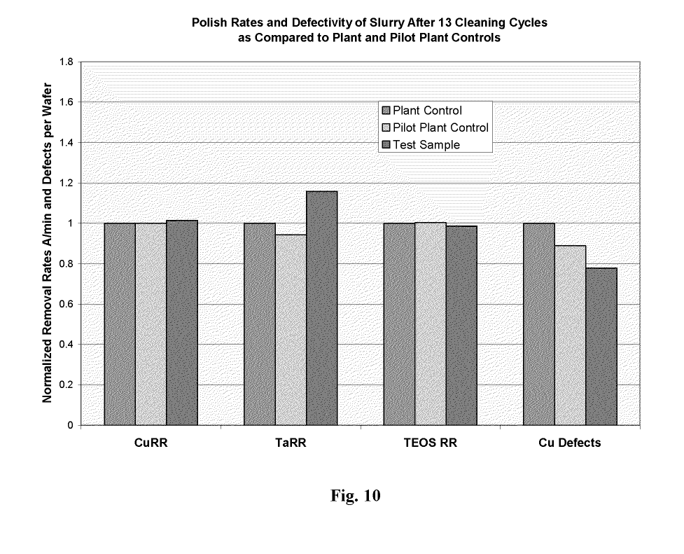

As used in FIGS. 6-10, MPS is the mean particle size in nanometers. LPC is large particle counts. K is potassium. A/min refers to Angstroms per minute. RR is removal rate. TEOS RR is the removal rate of oxide (TEOS) layer. Filter A is a 0.5 micron filter commercially available from Pall Corporation, Filter B is a 1.0 micron filter commercially available from Pall Corporation, and Filter C is a 0.5 μm filter commercially available from Pall Corporation. IPEC is the name of the company that makes the polishing tool in FIG. 10. Cu defectivity was determined by looking at 9 sites on an 8 inch copper wafer and taking the average number of defects as seen through a 200× magnified microscope.

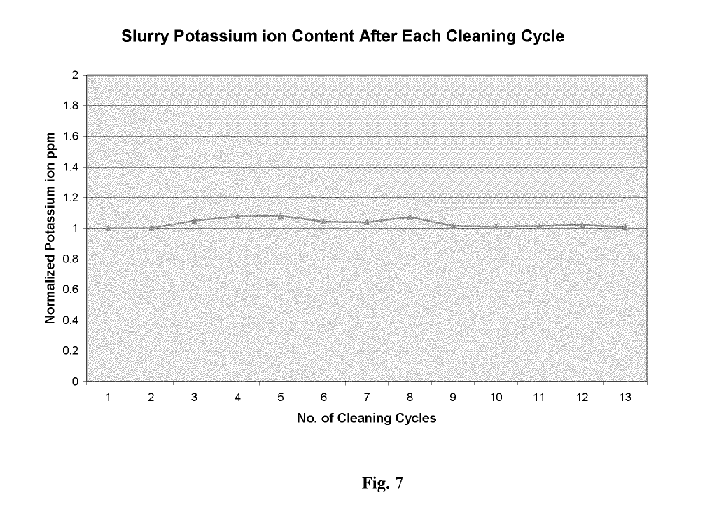

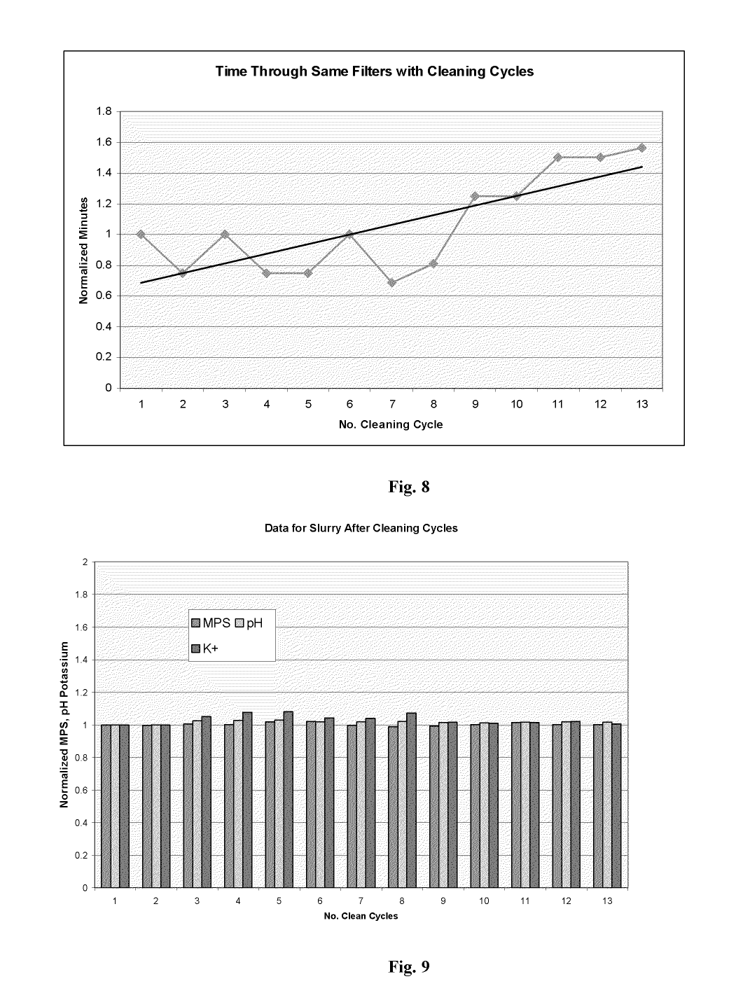

FIG. 6 graphically depicts filtered slurry large particle counts for 1004>0.56 μm after dynamic filter cleaning process. FIG. 7 graphically depicts the slurry potassium ion content after each cleaning cycle. FIG. 8 graphically depicts the time in minutes that the slurry was filtered with cleaning cycles. FIG. 9 graphically depicts data for the slurry after cleaning cycles. FIG. 10 graphically depicts polish rates and defectivity of the slurry after 13 clean cycles using the same filters as compared to plant and pilot plant controls.

From the data shown in FIGS. 6-10, it was determined that LPC for the test batches continued to improve with each cleaning cycle. The minutes the slurry was filtered before 12 psi differential pressure tended to increase with increasing number of cleaning cycles. The potassium ion level did not change throughout the cleaning cycles on the test batch. There was no effect on removal rates or defectivity from standard plant produced material and the cleaned filters. There was no effect on the final product from the cleaning solution. The data shows that the cleaning method of this disclosure can be used to precondition a filter prior to filtration.

### Example 6

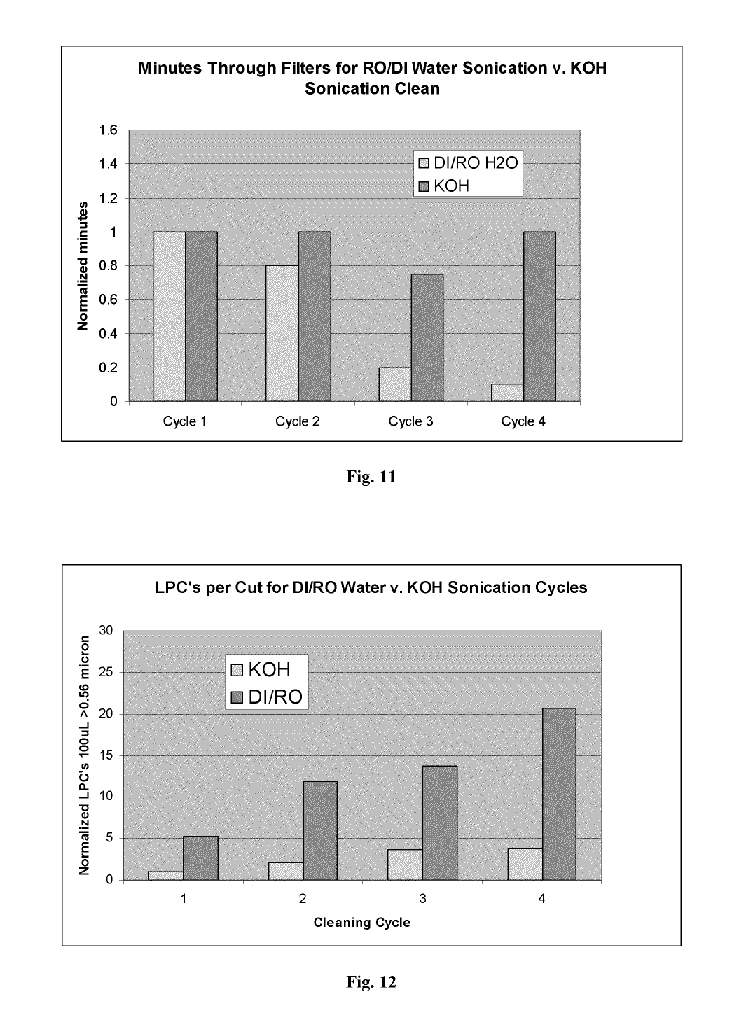

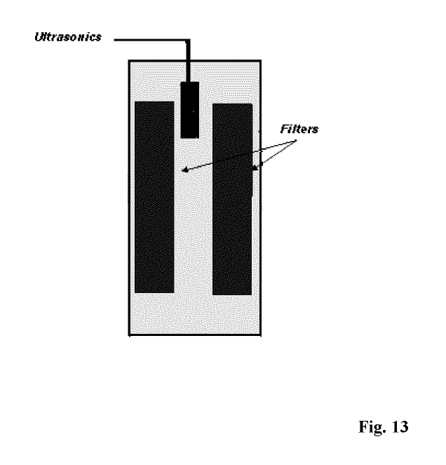

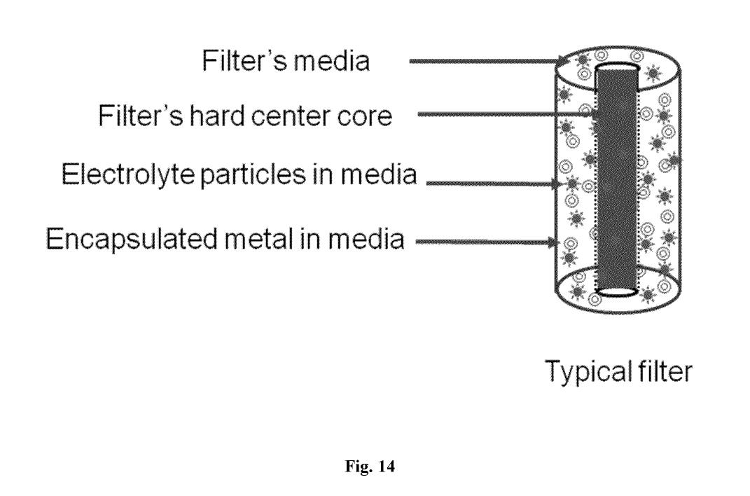

A cartridge filter was installed in a standard 1 inch filter housing for each experiment. A slurry (i.e., fumed silica dispersion) was pumped through the housings at a steady rate of 120 milliliters/minute. The slurry pumping was continued until a differential pressure of 15 psi was achieved on any one filter. A dip tube into unfiltered material was pulled, and the housings were pumped through and drained of residual slurry. The filter was taken out of the housing, and a first manual water rinse was performed. The filter was then placed in a 22.5% KOH solution at a temperature of 50° C. and sonicated for 10 minutes. The filter was removed and a second water rinse was performed, then filtration was started again with the slurry. The above steps were repeated until a desired quantity was filtered. Each cut of slurry was put through the filters prior to achieving the differential pressure of 15 psi. The pH, MPS (Mean Particle Size), LPCs (Large Particle Counts) and potassium ions were taken for each cut of slurry. For control testing, samples were filtered with same filter set up and slurry as above but the sonication occurred with DI/RO (deionized/reverse osmosis) water. The results are shown in FIGS. 11-12.

FIG. 11 graphically depicts minutes through each cleaning of filters for both DI/RO and KOH sonication. FIG. 12 graphically depicts LPC's for each DI/RO and KOH sonication cuts per cleaning cycle.

From the data as shown in FIGS. 11 and 12, it was determined that the filters cleaned out easily with KOH. The filter was able to repeat time through after each cleaning process with KOH, showing good repeatability of the slurry and the process. The LPCs for the RO/DI cleanings were severely affected by the rinses.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method for removing particles or deposits from a surface having particles or deposits thereon, said method comprising contacting said surface with a chemical composition sufficient to selectively dissolve and remove at least a portion of said particles or deposits from said surface, wherein said chemical composition is compatible with said surface.

2. The method of claim 1 wherein said chemical composition comprises a chemical solution or a chemical mixture.

3. The method of claim 1 wherein said chemical composition comprises a liquid, a vapor, or a gas.

4. The method of claim 1 wherein said surface is selected from a porous surface, a media for cartridge, pleated or membrane filters, and an internal wall of a tank or filter housing.

5. The method of claim 1 wherein the particles or deposits are removed under static or dynamic condition.

6. The method of claim 1 wherein said chemical composition is heated to a temperature of greater than about 20° C.

7. The method of claim 1 wherein the chemical composition comprises a solvent or etchant, said solvent or etchant selected from an organic acid, an inorganic acid, an alkali, a salt, a surface active agent, and mixtures thereof.

8. The method of claim 1 wherein said particles or deposits comprise silica, alumina, ceria, metals and metal oxides, organic particles, or mixtures thereof.

9. The method of claim 1 wherein said particles or deposits comprise silica and said chemical composition comprises an alkali containing NaOH, KOH, or their compounds or mixtures.

10. The method of claim 1 wherein said chemical composition comprises (i) an inorganic acid, an organic acid, an organic salt, an inorganic salt, or mixtures thereof, or (ii) an inorganic base, an organic base, an organic salt, an inorganic salt, or mixtures thereof.

11. The method of claim 1 further comprising passing said chemical composition, after particle or deposit dissolution, through an ion exchange system to regenerate said chemical composition.

12. The method of claim 1 wherein the particles or deposits are from a CMP (chemical mechanical polishing) slurry or solution.

13. The method of claim 1 wherein the removing is assisted by sound wave energy.

14. A system for removing particles or deposits from a surface having particles or deposits thereon, said system comprising at least one vessel, at least one enclosure containing a surface having particles or deposits thereon, one or more pumps, and one or more valves; said at least one vessel suitable for holding a chemical composition; wherein said at least one vessel is in fluid communication with said at least one enclosure, and said at least one enclosure is in fluid communication with said at least one vessel, to form at least a primary chemical composition circulation loop.

15. The system of claim 14 further comprising at least one heating source, said at least one heating source suitable for supplying energy to said chemical composition; wherein said at least one vessel is in fluid communication with said at least one heating source, said at least one heating source is in fluid communication with said at least one enclosure, said at least one enclosure is in fluid communication with said at least one heating source, and said at least one heating source is in fluid communication with said at least one vessel, to form at least a secondary chemical composition circulation loop.

16. The system of claim 14 further comprising at least one ion exchange system, said ion exchange system suitable for regenerating said chemical composition; wherein said at least one vessel is in fluid communication with said at least one enclosure, said at least one enclosure is in fluid communication with said at least one ion exchange system, and said at least one ion exchange system is in fluid communication with said at least one vessel, to form at least a secondary chemical composition circulation loop.

17. The system of claim 15 further comprising at least one ion exchange system, said ion exchange system suitable for regenerating said chemical composition; wherein said at least one vessel is in fluid communication with said at least one heating source, said at least one heating source is in fluid communication with said at least one enclosure, said at least one enclosure is in fluid communication with said at least one heating source, said at least one heating source is in fluid communication with said at least one ion exchange system, and said at least one ion exchange system is in fluid communication with said at least one vessel, to form at least a tertiary chemical composition circulation loop.

18. The system of claim 14 which is portable or permanent.

19. A method for removing particles or deposits from a surface having particles or deposits thereon, said method comprising:
(i) providing at least one vessel suitable for holding a chemical composition; at least one enclosure containing a surface having particles or deposits thereon; and one or more pumps and one or more valves suitable for controlling flow of said chemical composition;
(ii) conveying said chemical composition from said at least one vessel to said at least one enclosure containing a surface having particles or deposits thereon;
(iii) contacting said surface with said chemical composition sufficient to selectively dissolve and remove at least a portion of said particles or deposits from said surface, wherein said chemical composition is compatible with said surface; and
(iv) conveying spent chemical composition from said at least one enclosure to said at least one vessel.

20. The method of claim 19 further comprising:
(v) providing at least one heating source suitable for supplying energy to said chemical composition;
(vi) conveying said chemical composition from said at least one vessel to said at least one heating source;
(vii) conveying said chemical composition from said at least one heating source to said at least one enclosure containing a surface having particles or deposits thereon;
(viii) conveying spent chemical composition from said at least one enclosure to said at least one heating source; and
(ix) conveying said spent chemical composition from said at least one heating source to said at least one vessel.

21. The method of claim 19 further comprising:
(x) providing at least one ion exchange system suitable for regenerating said chemical composition;
(xi) conveying said spent chemical composition from said at least one enclosure to said at least one ion exchange system, and regenerating said spent chemical composition; and
(xii) conveying regenerated chemical composition from said at least one ion exchange system to said at least one vessel.

22. The method of claim 20 further comprising:
(x) providing at least one ion exchange system suitable for regenerating said chemical composition;
(xi) conveying said spent chemical composition from said at least one heating source to said at least one ion exchange system, and regenerating said spent chemical composition; and
(xii) conveying regenerated chemical composition from said at least one ion exchange system to said at least one vessel.

23. A composition for removing particles or deposits from a surface having particles or deposits thereon, said composition comprising a chemical composition sufficient to selectively dissolve and remove at least a portion of said particles or deposits from said surface, wherein said chemical composition is compatible with said surface.

24. A media treated by a method, said media comprising a surface having particles or deposits thereon, said method comprising removing particles or deposits from said surface by contacting said surface with a chemical composition sufficient to selectively dissolve and remove at least a portion of said particles or deposits from said surface, wherein said chemical composition is compatible with said surface.

25. A method for preconditioning a media, said media comprising a surface having particles or deposits thereon, said method comprising contacting said surface with a chemical composition sufficient to selectively dissolve and remove at least a portion of said particles or deposits from said surface, wherein said chemical composition is compatible with said surface.
